(19) United States
(12) Patent Application Publication
(10) Pub. No.: US 2026/0330479 A1
(43) Pub. Date: Oct. 22, 2026

(54) UID-BASED PHYSICAL PRODUCT AUTHENTICATION AND MONITORING

(71) Applicant: Fanlayer Licensing LLC, New York, NY (US)

(72) Inventor: Brian Matthew WILSON, New York, NY (US)

(73) Assignee: Fanlayer Licensing LLC, New York, NY (US)

(21) Appl. No.: 19/651,120

(22) Filed: Apr. 17, 2026

Related U.S. Application Data
(60) Provisional application No. 63/792,158, filed on Apr. 21, 2025.

(51) Int. Cl. G06Q 30/018; H04L 9/32

(52) U.S. Cl. CPC G06Q 30/0185; H04L 9/3213; H04L 9/3247; H04L 9/3271

(57) ABSTRACT

Disclosed herein are system, apparatus, article of manufacture, method and/or computer program product embodiments, and/or combinations and sub-combinations thereof, for linking a digital authentication signature to a physical product based on a unique identifier (UID) chip coupled to the physical product and configured to store a cryptographically secure UID. An example embodiment initializes a record associated with the digital authentication signature to track each scan of the UID element and each change to the digital authentication signature. The embodiment receives an activation scan from a verification client. The activation scan includes the UID associated with the product and a challenge request. The embodiment generates and transmits an encrypted challenge token to the verification client. The embodiment receives a challenge response that includes the challenge token and the UID. The embodiment validates the challenge response and, in response to a successful validation, updates the record associated with the digital authentication signature.

### CROSS REFERENCE TO RELATED APPLICATIONS

This application claims priority to U.S. Provisional Patent application No. 63/792,158 filed on Apr. 21, 2025, and entitled, “AI-Powered Fan Engagement Ecosystem with Secure UID Authentication, Monetization Engine, and Multi-Device Personalization,” which is herein incorporated by reference in its entirety.

### BACKGROUND

Product authentication systems facilitate the verification of authentic consumer products and have become increasingly important as counterfeiting has grown in volume and sophistication across industries ranging from luxury goods to consumer electronics and collectibles. Traditional product authentication approaches commonly rely on visually scannable elements, such as barcodes, quick response (QR) codes, alphanumerical serial numbers, or scratch-off labels. These traditional product authentication approaches allow users, retailers, or third-party authenticators to verify an item's identity as an authentic product. While these systems are inexpensive and easy to deploy, they are inherently static because they are set at the time they're attached to the product and cannot be changed. Consequently, these approaches suffer from an easily reproducible nature that cannot adapt to events during the product lifecycle. For example, a QR code or serial number printed on packaging can be copied, photographed, or reprinted without degrading the original label, enabling counterfeiters to replicate or clone the authentication. Even scratch-off labels, which are used to hide a one-time code, can be counterfeited by harvesting unused codes from genuine items, duplicating the unused codes across numerous fakes by simulating the appearance of an unused scratch-off label. As a result, visually scannable elements that only serve as static visual identifiers provide limited assurance of authenticity once the product is outside controlled distribution centers like storefronts. More recently, manufacturers have begun pairing static visual identifiers like QR codes or serial numbers with server-based validation, allowing a backend system to track whether a particular identifier has been scanned or redeemed previously. Although this approach enables detection of repeated scans for a single identifier, a counterfeiter may still intercept a genuine item early in the supply chain, prior to sale, and clone authentic visual identifiers and apply them to numerous fraudulent items.

In parallel, blockchain-based or non-fungible token (NFT)-based authentication systems have been proposed as decentralized approaches to verifying product authenticity. These systems typically record a digital token corresponding to a physical item onto an immutable ledger such that there is public verification of token ownership and transfer history. However, these digitally based authentication systems do not inherently provide a secure binding between the digital token and the physical product it represents, which creates a separation between the digital authentication and the physical product. In this scenario, the NFT or blockchain entry may confirm product authenticity, but there is nothing to prevent a counterfeiter from applying a QR code or serial number representing that digital token onto a fake product. Additionally, marking the genuine product with a visual identifier representing the digital token does not impede replication since the digital token remains authentic regardless of the physical product authenticity. Consequently, blockchain and NFT-based authentication approaches fail to address the issue of linking the physical product with a digital representation of authenticity.

### BRIEF DESCRIPTION OF THE DRAWINGS

The accompanying drawings are incorporated herein and form a part of the specification.

FIG. 1 is a block diagram of an example authentication platform, according to some aspects.

FIG. 2 shows a block diagram of an example enforcement engine, according to some aspects.

FIG. 3 shows an example process for activating a digital authentication signature corresponding to a physical product, according to some aspects.

FIG. 4 shows an example process for authenticating a scan of a UID element, according to some aspects.

FIG. 5 shows an example process for detecting anomalies in UID element scan data, according to some aspects.

FIG. 6 shows an example process for implementing multifactor authentication, according to some aspects.

FIG. 7 shows an example process for retrieving a digital authentication signature, according to some aspects.

FIG. 8 shows an example of a computer system, according to some aspects.

In the drawings, like reference numbers generally indicate identical or similar elements. Additionally, generally, the leftmost digit(s) of a reference number identifies the drawing in which the reference number first appears.

### DETAILED DESCRIPTION

Provided herein are system, apparatus, device, method and/or computer program product embodiments, and/or combinations and sub-combinations thereof, for a digital authentication system for linking a digital authentication signature to a physical product using a unique identification (UID) element coupled to the physical product. As described herein, a UID element may include any device-persistent identifier that can be cryptographically challenged to provide uniqueness. For example, a UID element may include a UID chip, a Near Field Communication (NFC) tag serial, a Bluetooth media access control (MAC) address, a quick-response (QR)-encoded hash, a hardware fuse, a blockchain token, or the like.

Using the embodiments described herein, a digital authentication signature that stores information (e.g., product lifecycle state, product ownership, etc.) related to a physical product may be linked to the physical product and stored in a global registry accessible from a server (e.g., a cloud-based server) for enhanced security and efficient authenticating throughout the product lifecycle.

Conventional approaches to authenticating physical products often require the use of visible, printed identifiers such as QR codes, barcodes, alphanumeric serial numbers, or scratch-off labels that reveal hidden codes. While advances have been made to incorporate these visual identifiers into centralized authentication platforms, their effectiveness remains limited by their inherently static and easily replicable nature. In many cases, these approaches can only track the activation of a product, which prevents tracking the rest of the product lifecycle (e.g., product use, product resale, product return, etc.). In particular, to authenticate a product using a visual identifier and a conventional authentication platform, a user still has to trust a visually exposed marker that can be copied, previously activated to another user, and/or spoofed without triggering any server-side alarms. This less secure process leaves the physical product open to counterfeiting opportunities during the product lifecycle that cannot readily be enforced against.

The embodiments described herein address the aforementioned technical problems via implementations that may be used to more securely authenticate and update lifecycle states of physical products in various contexts. For example, using the embodiments described herein, a digital authentication system may link a UID element coupled to a physical product to a digital authentication signature stored in a global registry to provide a secure authentication method to wirelessly verify the authenticity of the physical product. In this example, the digital authentication signature corresponds to the physical product and the UID element coupled to the physical product, allowing the authenticity of the physical product to be tracked through telemetric scans of the UID element rather than visual scans of a visual identifier like a barcode or QR code. Additionally, because the digital authentication signature is stored in a global server, the authentication status and lifecycle data corresponding to the physical product can be tracked throughout the product lifecycle, enabling modification of the authentication status and lifecycle state data beyond a single activation event. For example, a digital authentication system (DAS) may alter the digital authentication signature in response to UID scans corresponding to fan interaction events, ownership transfer events, counterfeit activity, policy or licensing actions, etc. Using the embodiments described herein, physical products may be securely authenticated and the product lifecycle state can be updated and monitored for counterfeit behavior and/or positive engagement of the product with entity environments.

Accordingly, the techniques described herein improve the functioning of a computing system by increasing the security of authentication across a network of verification clients, structuring the linking of physical products to digital authentication signatures with computer-interpretable rules to improve authentication monitoring throughout the product lifecycle, and protecting the authenticity of physical products from malicious counterfeiting.

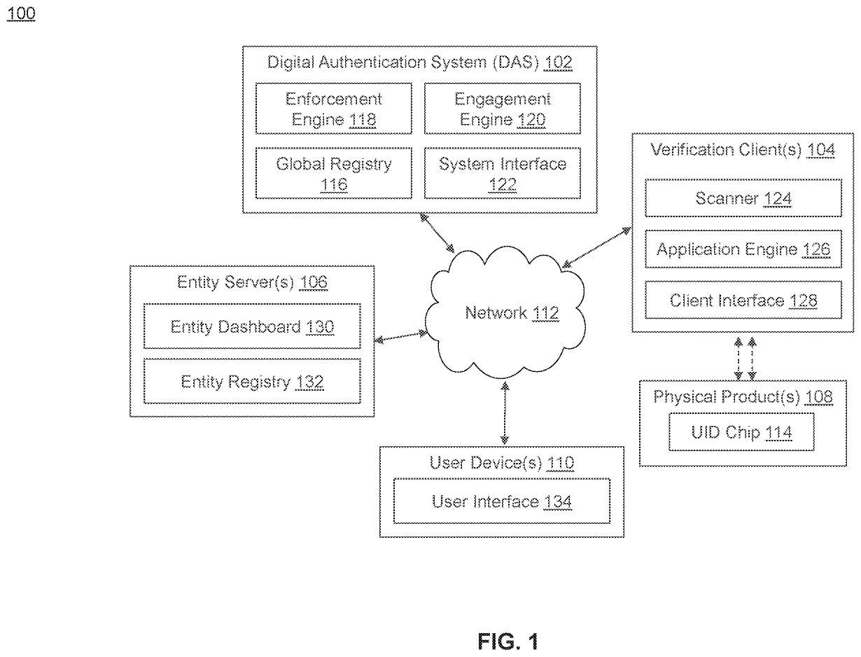

Various aspects of this disclosure may be implemented using and/or may be a part of the example authentication platform shown in FIG. 1. It is noted, however, that these environments are provided solely for illustrative purposes, and are not limiting. Aspects of this disclosure may be implemented using and/or may be part of environments different from and/or in addition to the authentication platform described herein, as will be appreciated by persons skilled in the relevant art(s) based on the teachings contained herein.

An example of the authentication platform shall now be described.

FIG. 1 shows an example block diagram of an authentication platform 100, according to some aspects. Operations described may be implemented by processing logic that may comprise hardware (e.g. circuitry, dedicated logic, programmable logic, microcode, etc.), software (e.g. instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Example authentication platform 100 may include a DAS 102, verification client(s) 104, entity server(s) 106, physical product(s) 108, and user device(s) 110. In some aspects, DAS 102, verification client(s) 104, entity server(s) 106 and user device(s) 110 may be communicatively coupled via network 112. Network 112 may include one or more networks such as local area networks (LANs), wide area networks (WANs), personal area networks (PANs), metropolitan area networks (MANs), enterprise networks, the Internet, etc., and may include one or more of wired and/or wireless portions. For example, network 112 may include wireless communication, wired communication, optical communication, ultrasonic communication, or a combination thereof. Satellite communication, cellular communication, Bluetooth, Infrared Data Association standard (IrDA), Wi-Fi, and worldwide interoperability for microwave access (WiMAX) may be examples of wireless communication that may be included in network 112. Cable, Ethernet, digital subscriber line (DSL), fiber optic lines, fiber to the home (FTTH), and plain old telephone service (POTS) may be examples of wired communication that may be included in the network 112.

In some aspects, example authentication 100 is provides functionality for authenticating and/or tracking data related to physical product(s) 108. Physical product(s) 108 may be physically coupled to UID element(s) 114. UID element(s) 114 may include any device-persistent identifier that can be cryptographically challenged to provide uniqueness. For example, a UID element may include a UID chip, a NFC tag serial, a Bluetooth MAC address, a QR-encoded hash, a hardware fuse, a blockchain token, or the like. UID element(s) 114 function as a reference point that DAS 102 leverages to locate an identity record and lifecycle state associated with a physical product 108.

In some aspects, UID element(s) 114 may include an integrated circuit or semiconductor device with a non-alterable, unique identifier (UID) embedded into its hardware. The UID may include a unique serial number, or the like. UID element(s) 114 may additionally store cryptographic keys, passwords, OEM signatures, digital certificates, etc. In some aspects, UID element(s) 114 are configured to implement hardware-level secure modules, such as a secure element (SE), trusted platform module (TPM) or digital certificate based systems. Implementation of hardware-level secure modules may enable cryptographic signing of verification requests and support tap-to-authenticate actions via near field communication (NFC), QR-scanning, or Bluetooth (BLE) handshake sequences. In some aspects, UID element(s) 114 may use challenge-response mechanisms to authenticate themselves to verification client(s) 104 and/or DAS 102.

In some aspects, UID element 114 may be coupled to wearable jewelry (e.g., rings, necklaces, bracelets, etc.) and/or wearable charm bracelets with individually attachable charms that each contain a UID element 114.

In some aspects, UID element 114 may be embedded in a sealable container (e.g., a sealable bag, box, etc.) that contains physical product 108. In this example, UID element 114 may be coupled to the physical product 108 in the sealable container such that UID element 114 represents physical product 108 without requiring the UID element 114 to be integrated on and/or in physical product 108. In this embodiment, the physical product 108 may be a collectible item (e.g., a move prop, a game-used item, a trading card, etc.) for which it is not desirable to directly attach a UID element 114.

In some aspects, UID element 114 may be coupled to a physical product 108 like a smart speaker or home hub (e.g., Amazon Alexa™, Google Home™, etc.). In this example, UID element 114 may be embedded in the circuitry or housing of the physical product 108 such that it remains wirelessly accessible to scanning by a verification client 104 without affecting other functions of the home hub device.

In some aspects, UID element 114 may be coupled to a physical product 108 that has integrated biometric sensing capabilities (e.g., a smart watch). In this example, UID element 114 may be paired with additional circuit components that allow for biometric data to be retrieved from the physical product 108 and shared wirelessly with scans by a verification client 104.

In some aspects, UID element 114 may be paired with additional circuit components, such as but not limited to, light emitting diodes (LEDs), rechargeable batteries, sensors, reed switches, and/or NFC/Bluetooth modules, in addition to being coupled to the physical product 108. In this example, to provide power to charge a rechargeable battery, a wireless charging coil may be integrated such that the additional circuit components may be charged with a wireless charging pad. The wireless charging pad may include functional components, such as but not limited to, a primary induction coil, a shielding layer, ferrite backing material, a power conversion module, a rectifier, a resonant capacitor network, a microcontroller, and/or a housing. The UID element 114 may be embedded in the circuitry or housing of the wireless charging pad such that it remains wirelessly accessible to a verification client 104.

In some aspects, UID element 114 may embed a one-time ticket token compliant with International Organization for Standardization (ISO)/International Electrotechnical Commission (IEC) 18013-5. This may enable direct access to an area without a separate pass.

In some aspects, a UID may be cryptographically injected and signed into the metadata of each UID element 114 during manufacture using a licensed factory certificate chain (e.g., X.509). DAS 102 may be configured to authenticate and manage records associated with one or more UID element(s) 114 coupled to one or more physical product(s) 108. DAS 102 may include a global registry 116, enforcement engine 118, an engagement engine 120, and a system interface 122. Aspects of DAS 102 may be implemented as one or more servers and/or one or more cloud servers. DAS 102 may also be implemented as a variety of centralized or decentralized computing devices. For example, DAS 102 may operate on a mobile device, a laptop computer, a desktop computer, grid-computing resources, a virtualized computing resource, cloud computing resources, peer-to-peer distributed computing devices, a server farm, or a combination thereof. DAS 102 may be centralized in a single device, distributed across multiple devices within a cloud network, distributed across different geographic locations, or embedded within a network, such as network 112.

DAS 102 may perform various activation and authentication protocols in response to a scan of a UID element 114 by a verification client 104. DAS 102 may use a UID received in scan data to locate a product identity record stored in global registry 116. For example, Global registry 116 may store one or more digital authentication signatures corresponding to UIDs of one or more physical products 108. A digital authentication signature may include an authentication status related to a physical product 108 (e.g., inactive, active, expired, revoked, restricted, suspended, etc.), product-specific information related to the physical product 108 (e.g., a description of physical product 108, information of an entity related to physical product 108, information of a user related to physical product 108, a record of ownership of physical product 108, etc.). In some aspects, a digital authentication signature may provide a record of ownership of for the physical product 108.

In some aspects, a digital authentication signature may include UID lifecycle metadata that includes capability flags that define operations permitted for the UID. Capability flags may be enforced at each authentication or transfer event and may be updated based on an authentication status of a physical product 108 or a policy profile. UID lifecycle metadata may also include configurable thresholds, such as time-based thresholds, usage-count thresholds, scan-frequency thresholds, and the like. The UID may transition into a new lifecycle state when one of the thresholds in reached. The new state can include privilege upgrade, renewal requirement, privilege downgrade, inactivation, etc.

In some aspects, DAS 102 may choose the authentication protocol based on a current authentication status of a digital authentical signature and/or contextual input signals, such as geographic location, time of day, etc.

Enforcement engine 118 may be configured to manage lifecycle state transitions of a physical product 108. For example, enforcement engine 118 may be configured to modify digital authentication signature(s) of a physical product(s) 108 based on incoming scan data from UID elements(s) 114. Enforcement engine 118 may include models that are trained to detect anomalous behavior related to a physical product 108. In some aspects, the models of enforcement engine 118 may be configured to detect anomalous behavior according to rules-based interpretation of the product lifecycle and generate enforcement actions that modify the digital authentication signature of a physical product 108 based on calculated anomaly scores for the detected anomalous behavior. Anomalous behavior may include examples, such as but not limited to: DAS 102 receiving scans of a physical product 108 from multiple verification clients 104 in geographically different locations within anomalous timeframes that suggest cloning of the UID element 114; DAS 102 receiving multiple scans of a physical product 108 from a verification client 104 at anomalous frequencies that suggest malicious scanning practice using the verification client 104; DAS 102 receiving anomalous requests to change the registered ownership of a physical product 108 that suggest malicious activity; and/or DAS 102 receiving information from an entity server 106 indicating that the entity is aware of malicious activity related to a physical product 108. In some aspects, enforcement engine 118 may, based on detecting anomalous behavior, calculate an anomaly score to quantify the anomalous behavior. In this example, enforcement engine 118 may compare the calculated anomaly score to a threshold value above which a detected anomalous behavior is considered anomalous. In some aspects, enforcement engine 118 may, based on the anomaly score crossing the threshold value, generate enforcement actions that modify the digital authentication signature of a physical product 108 to defend against the detected anomalous behavior. For example, enforcement engine 118 may generate enforcement actions, such as but not limited to: suspending a digital authentication signature so that properties of the digital authentication signature may not be changed; revoking the authentication status of a digital authentication signature so that the physical product 108 is no longer considered authentic; and/or flagging a digital authentication signature so that the corresponding physical product 108 is still considered authentic, but future scans of the UID element 114 will be monitored with extra scrutiny.

In some aspects, DAS 102 may use enforcement engine 118 to manage conditional registry state transitions. For example, enforcement engine 118 may alter the digital authentication signature associated with a physical product 108 upon receipt of activation data, authentication data, transaction data, or the like. Conditional registry state transitions may be specified in licensing-specific metadata or embedded rulesets associated with the digital authentication signature that define royalty splits, access restrictions, resale eligibility, or monetization pathways unique to a given brand-artist collaboration. Conditional state transitions may also depend on the current authentication status of the digital authentication signature. In one example, enforcement engine 118 may, during a resale event of physical product 108, conditionally update an ownership record of the digital authentication signature after receiving confirmation that a portion of a resale value (e.g., royalty payment) has been allocated to an original entity associated with the physical product. In some aspects, DAS 102 may temporarily modify the authentication status of the digital authentication signature based on a lack of confirmation that a royalty allocation was paid during a resale event. For example, the authentication status may be revoked or suspended until correct royalty payments are made to the corresponding entity.

In some aspects, DAS 102 may leverage enforcement engine 118 to enforce limitations such as expiration-based access, single-use entitlements, region-specific unlocks, or artist-tiered reward logic embedded directly into UID element 114 or stored in a policy profile associated with the digital authentication signature.

Engagement engine 120 may be configured to analyze behavior of a user of a physical product 108. In some aspects, engagement engine 120 may receive scan data (e.g., timestamp, scan location, etc.) related to authenticated scans of UID element 114 from verification clients 104. Engagement engine 120 may use the scan data to monitor the number of times a physical product 108 is scanned in a fan engagement environment, such as but not limited to, concerts, amusement parks, sports games, conventions, etc. Engagement engine 120 may then input the scan data into one or more models to generate an engagement score that quantifies the interaction of a user with the fan engagement environment.

In some aspects, such as when UID element 114 is coupled to a physical product with biometric sensors, engagement engine 120 may receive biometric data from a user, such as heart rate, galvanic skin response, etc. The biometric data may be used alone, or in addition to the scan data to calculate an engagement score for the user. In one non-limiting example, engagement engine 120 may calculate a weighted sum of biometric intensity (generated from biometric inputs), user activity (generated from one or more of scan frequency, scan timestamps, and scan location), and transaction signals. The engagement score may be calculated periodically at predefined intervals, or in response to a trigger, such as a scan of UID element 114, a user heart rate reaching a threshold value, etc.

In some aspects, engagement engine 120 may use the engagement score to select a cryptographic key or privilege flag that determines which modules may be decrypted or which device functions may be enabled for the user. The modules/device functions may include exclusive content, reward redemption, and/or entry to events. For example, engagement engine 120 may, in response to the engagement score reaching (or falling below) a predetermined value, update an access tier of the user of physical product 108.

In some aspects, engagement engine 120 may include one or more artificial intelligence models that suggest content to a user based on the user's product interaction history and/or the engagement score. Inputs to the artificial intelligence models may include, but are not limited to, the time and location of previous UID element scans, user defined preferences, and/or biometric data.

In some aspects, engagement engine 120 may send re-engagement signals to the user if the user has not scanned UID element 114 within a predefined interval or if the engagement score falls below a predefined value. The re-engagement signal may be sent directly to physical product 108 or to user device 110 associated with the user of physical product 108. Engagement engine 120 may confirm that the lifecycle state in the digital authentication signature is active before sending a re-engagement signal.

System interface 122 may be configured to establish secure connections and exchange data with verification client(s) 104, UID element(s) 114, entity server(s) 106, and/or user device(s) 110. For example, system interface 122 may implement any known application programming interface (API) architectures or protocols, including, but not limited to Representational State Transfer (REST), Simple Object Access Protocol (SOAP), graph query languages (e.g., GraphQL), gRPC Remote Procedure Call (gRPC), WebSocket, etc.

Verification client(s) 104 may enable data exchange between UID element 114 and DAS 102. For example, verification client(s) 104 can include authorized point-of-sale (POS) systems configured to generate an activation scan during an initial sale of a physical product 108. Verification client(s) 104 may also include authorized authentication devices configured to generate an activation scan during a secured coupling of the UID element 114 to the physical product 108 and facilitate future authentication scans of UID element 114. Verification client(s) 104 may be one or more of a desktop computer, a laptop computer, a tablet, a mobile phone, a smart appliance such as a smart television, and/or a wearable apparatus of the user that includes a computing device (e.g. a smartwatch, smart glasses, or a virtual or augmented reality computing device). Verification client(s) 104 may include a scanner 124, an application engine 126 and a client interface 128. Verification client(s) 104 may leverage scanner 124 to exchange data, such as UIDs and cryptographic information, with UID element(s) 114. For example, scanner 124 may leverage any known short-range data exchange procedure, such as NFC or Bluetooth. In some aspects, such as when verification client(s) 104 do not have network access to DAS 102, verification client(s) 104 may validate a scan of a UID element 114 locally. For example, verification client(s) 104 may, after scanning a UID element 114, engage in a challenge-response mechanism directly with the UID element 114. Verification client(s) 104 may then, upon gaining network access to DAS 102, send information, such as updates to the digital authentication signature and/or scan data to DAS 102. DAS 102 may the update the digital authentication signature accordingly.

Application engine 126 may execute one or more software applications on verification client 104. In some aspects, application engine 126 may facilitate a cryptographic authentication process between DAS 102 and UID element 114. For example, application engine 126 may use data received from UID element 114 to generate a cryptographic challenge request for DAS 102. Application engine 126 may then establish a secure connection with DAS 102 (e.g., through system interface 122) and send the challenge request. After receiving an encrypted challenged token from DAS 102, application engine 126 may leverage scanner 124 to send the encrypted challenge token to UID element 114 and receive a challenge response. Application engine 126 may then send the challenge response to the DAS 102 and receive a verification message. In some aspects, application engine 126 may send scan data to DAS 102. For example, application engine 126 may send a geolocation, a timestamp, and/or an identification number corresponding to the verification client. Application engine 126 may also generate a proof of sale for a physical product 108.

Client interface 128 may be configured to render content, including an authentication status of a physical product, a verification message, and content modules, to a user of verification client 104 using one or more output devices. For example, verification client 104 may include a display or projector that enables content to be provided for visual presentation to a user. Alternatively or additionally, verification client 104 may include one or more speakers that enable content to be provided for audible presentation to a user. In some aspects, a user may generate a request through client interface 128. The request may be related to the digital authentication signature of a physical product 108, such as but not limited to, a request to register ownership of a physical product 108 to a user, a request to transfer ownership of a physical product 108 from one user to another, a request to activate (or reactivate) a physical product 108, and the like.

In some aspects, DAS 102 may connect to an entity server 106 coupled to network 112 to provide information about a digital authentication signature associated with a physical product 108 that may be associated with either an entity and/or a user. Entity server 106 may include an entity dashboard 130 for displaying information and providing a user interface for an entity representative to interact with information received from DAS 102. In some aspects, entity dashboard 130 features real-time data aggregation from verification client(s) 104, analytics of usage patterns, automatic detection of duplicate UIDs, and comprehensive insights into individual fan engagement levels, re-engagement outcomes, preference-driven recommendations, lifecycle events, and tracking of physical product resales, and new physical product pairings. Entity dashboard 130 may enable licensing partners to proactively monitor and protect their intellectual property and fan interactions globally, with real-time alerts for unauthorized resale attempts and counterfeit detection. Entity server 106 may also include an entity registry 132 that stores copies of digital authentication signatures for physical products 108 that are related to an entity. In some aspects, DAS 102 may receive updates to one or more digital authentication signatures form entity server 106. For example, entity server 106 may request a change to an authentication status of a physical product 108 if it reported lost or stolen.

User device(s) 110 may include one or more of a desktop computer, a laptop computer, a tablet, a mobile phone, a smart appliance such as a smart television, and/or a wearable apparatus of the user that includes a computing device (e.g. a smartwatch, smart glasses, or a virtual or augmented reality computing device). In some aspects, a user of physical product 108 may receive content or information related to physical product 108 via user interface 134 of user device 110.

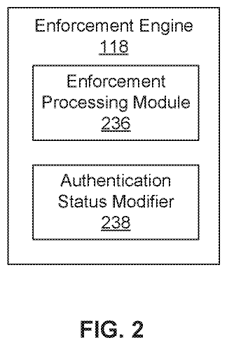

FIG. 2 provides more detail of enforcement engine 118, according to some aspects. Enforcement engine 118 may include an enforcement processing module 236 and an authentication status modifier 238. Enforcement processing module 236 may receive scan data from one or more verification clients 104. The scan data may include UID scan telemetry data from one or more verification clients, including but not limited to, timestamps, device identifiers, geographic locations of scans, and scan frequency.

Enforcement processing module 236 may be configured to detect one or more anomalies within the scan data. Anomalies may include unexpected patterns within the scan data, such as geographic inconsistencies, abnormal scan frequencies, spatiotemporal inconsistencies, unidentified verification clients, and duplicate UIDs. In some aspects, anomalies may indicate malicious activity. For example, spatiotemporal inconsistencies, duplicate UIDs, and abnormal scan frequencies within the scan data may indicate that a UID element has been cloned, duplicated, or stolen. In another example, scan patterns originating from identical device clusters and high scan repetition may indicate hoarding or other unauthorized automated behavior.

In some aspects, enforcement processing module 236 may detect anomalies by comparing the scan data to one or more operational thresholds. The operational thresholds may define authorized geographic zones (e.g., North America), outline a range of allowed or expected scan frequencies for predefined time intervals, define spatiotemporal rules (e.g., minimum time intervals for scans originating from different geographic locations), define minimum verification client trust scores, etc. In some aspects, the operational thresholds are based on statistical baseline models that define expected ranges for the scan data (e.g., expected scan frequency). Enforcement processing module 236 may determine that an anomaly is present when one or more aspects of the scan data fail to meet an operational threshold.

In some aspects, enforcement processing module 236 may leverage an artificial intelligence model to detect anomalies within the scan data. The artificial intelligence model may include one or more classification models that are configured to extract features from the scan data and classify the features as normal/abnormal. The artificial intelligence model may include separate classification models for different types of anomalies (e.g., a first model to detect abnormal scan patterns, a second model to detect spatiotemporal inconsistencies, etc.). The artificial intelligence model may be trained on historical and/or synthetic UID scan data.

Authentication status modifier 238 may be configured to alter the status of a digital authentication signature corresponding to a physical product when enforcement processing module 236 detects an anomaly. For example, authentication status modifier 238 may freeze a digital authentication signature so that properties of the digital authentication signature may not be changed; revoke the authentication status of a digital authentication signature so that the physical product 108 is no longer considered authentic; and/or flag a digital authentication signature so that the corresponding physical product 108 is still considered authentic, but future scans of the UID element 114 will be monitored with extra scrutiny.

In some aspects, authentication status modifier 238 may alter the digital authentication signature to reflect lifecycle state transitions outlined in a policy profile. For example, authentication status modifier 238 may update a user status in response to increased (or decreased) fan engagement, update an ownership record of the physical product based on confirmation of a royalty payment, etc.

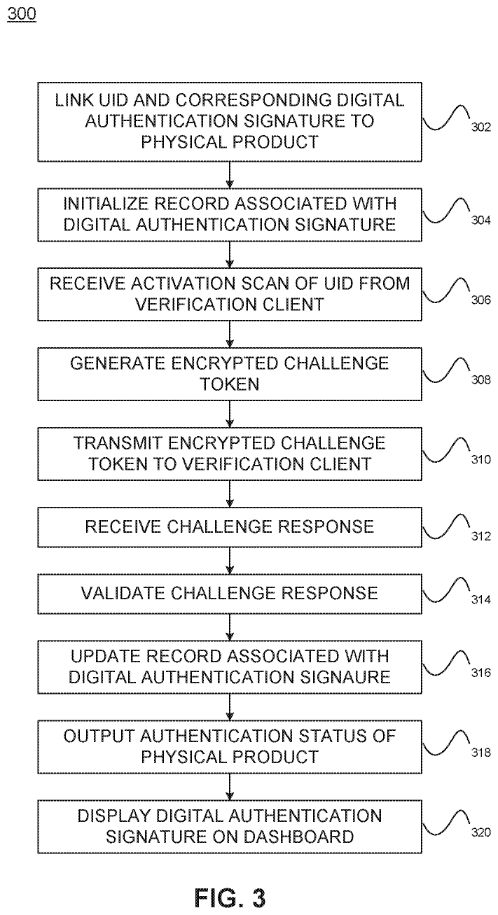

FIG. 3 shows an example process 300, according to some aspects. Process 300 may describe an example workflow for initializing and activating digital records corresponding to physical products based on UID elements coupled to the physical products. Process 300 may occur in response to an activation scan of a UID element 114 coupled to a physical product 108 performed by a verification client 104. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art. Process 300 shall be described with reference to FIG. 1. However, process 300 is not limited to those example aspects.

At 302, DAS 102 may link a digital authentication signature to a physical product 108. The digital authentication signature may correspond to a UID element 114 that is coupled to the physical product 108.

At 304, DAS 102 may initialize a record associated with the digital authentication signature. The record may track each scan of UID element 114 and each change to the digital authentication signature (e.g., change in authentication status of the physical product, change in ownership of the physical product, etc.). At initialization, an authentication status of the physical product may be inactive.

At 306, DAS 102 may receive activation scan data of UID element 114 from verification client 104. The verification client 104 may include an authorized point-of-sale (POS) systems configured to generate an activation scan during an initial sale of a physical product 108 or an authorized authentication device configured to generate an activation scan during a secured coupling of a UID element 114 to a physical product 108. The activation scan data may include the UID associated with the product and a challenge request. The activation scan data may also include metadata related to the scan, including an identity of verification client 104, a location of verification client 104, a proof of sale, a timestamp for the activation scan, a request to activate the physical product, etc.

At 308, DAS 102 may generate an encrypted challenge token. The encrypted challenge token may be unique to the challenge request. For example, the encrypted challenge token may include a randomly generated number or string.

At 310, DAS 102 may transmit the encrypted challenge token to verification client 104. Verification client 104 may transmit the encrypted challenge token to UID element 114, which generates a challenge response. The challenge response may combine the encrypted challenge token with a secret (e.g., through hashing, applying a cryptographic operation, etc.). UID element 114 may transmit the challenge response back to verification client 104, which then transmits the challenge response to DAS 102 for validation.

At 312, DAS 102 may receive the challenge response from verification client 104. The challenge response may include the UID or other identifiers. In some aspects, the encrypted challenge token generated by DAS 102 and corresponding response received from verification client 104 form part of a defined challenge-response validation process for a UID interaction, not a general data transmission.

At 314, DAS 102 may validate that the challenge response. For example, DAS 102 may leverage a cryptographic key to confirm that the challenge response is correct. DAS 102 may additionally validate the activation scan metadata. For example, DAS 102 may check for a proof of sale, confirm that the validation client is authorized, and the like. By validating the activation scan metadata, DAS 102 may prevent unauthorized devices from altering the record associated with the digital authentication signature.

At 316, DAS 102 may, in response to validating the challenge response (and optionally activation scan metadata), update the record associated with the digital authentication signature. If the challenge response is valid, DAS 102 may change the authentication status of the physical product to active. If the challenge response is invalid, DAS 102 may suspend or revoke the UID, or the status may remain unchanged (e.g., remain in an inactive state).

In some aspects, DAS 102 may update the digital authentication signature to include data related to an entity and/or user associated with physical product 108. For example, when a digital authentication signature is activated upon an initial sale of the product, the digital authentication signature may be updated to include data related to the new owner. Alternatively, if physical product 108 is activated by an entity before it is sold, the digital authentication signature may be updated to include data related to the entity.

At 318, DAS 102 may output, via verification client 104, the authentication status of the physical product 108. For example, DAS 102 may output an “active” status in response to successful validation at 314 or may output a “suspended,” “restricted,” “revoked,” or “inactive” state if the validation at 314 was unsuccessful.

At 320, DAS 102 may display one or more digital authentication signatures corresponding to one or more physical products associated with an entity or a user. The digital authentication signatures may be displayed via entity dashboard 130 or user interface 134 of user device 110.

Process 300, as described above, provides examples of specific activation and authentication schemes. However, these examples are not meant to be limiting nor meant to represent an exhaustive list of possible implementations. The scope of the technology disclosed herein is not limited to only these examples, and other implementations are contemplated as appreciated by one skilled in the art.

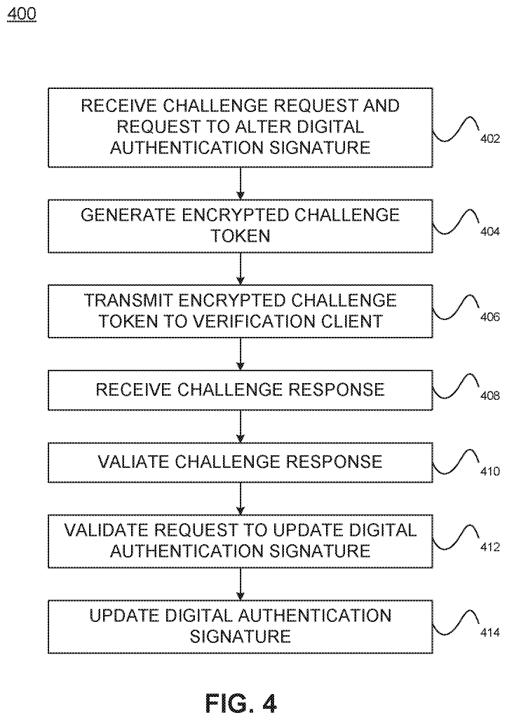

FIG. 4 shows a flowchart of an example process 400, according to some aspects. Process 400 may illustrate a workflow for authenticating requests to alter the digital authentication signature corresponding to a physical product 108. The request may be initiated by a scan of a UID element 114 coupled to the physical product 108 by one of verification client(s) 104. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art. Process 400 shall be described with reference to FIG. 1. However, process 400 is not limited to those example aspects.

At 402, DAS 102 may receive a challenge request from a verification client 104. The challenge request may include a UID corresponding to a physical product 108. DAS 102 may also receive scan data from verification client 104 including, but not limited to, an identifier for verification client 104, a trust score for the verification client 104, a geolocation of the verification client 104, a timestamp, etc. In some aspects, DAS 102 may additionally receive a request to alter the digital authentication signature corresponding the physical product 108. For example, DAS 102 may receive a request to update an ownership record for physical product 108, a request to reactivate a UID, a request to update a user engagement record, etc. The request may include verification information, such as a proof of sale.

At 404, DAS 102 may generate an encrypted challenge token based on the challenge request. The encrypted challenge token may be unique to the challenge request. For example, the encrypted challenge token may include a randomly generated number or string.

At 406, DAS 102 may may transmit the encrypted challenge token to verification client 104. Verification client 104 may transmit the encrypted challenge token to UID element 114, which generates a challenge response. The challenge response may combine the encrypted challenge token with a secret (e.g., through hashing, applying a cryptographic operation, etc.). UID element 114 may transmit the challenge response back to verification client 104, which then transmits the challenge response to DAS 102 for validation.

At 408, DAS 102 may receive the challenge response from verification client 104. The challenge response may include the UID or other identifiers.

At 410, DAS 102 may validate the challenge response. For example, DAS 102 may leverage a cryptographic key to confirm that the challenge response is correct.

At 412, DAS 102 may validate the request to alter the digital authentication signature and/or scan data against a policy profile associated with the physical product 108. In some aspects, the policy profile may specify conditions for altering the digital authentication signature. For example, the policy profile may require that a transfer of ownership includes a point of sale from an authorized verification client, define a geographic area in which certain actions may occur, apply restrictions based on a temporal frequency of scans received from a UID element 114, require a confirmation of royalty payment before transferring ownership of physical product 108, etc.

At 414, DAS 102 may update the digital authentication signature based on one or more of the validation of the challenge response at 410, the request received at 402 and validation of the request and/or scan data at 412. For example, DAS 102 may change the authentication status of a UID to restricted or revoked if the validation of the challenge response at 410 fails or if the scan data does not meet constraints outlined in the policy profile (e.g., a scan of UID element 114 originates outside of allowed geographic area), change a record of ownership for the physical product in response to an authorized sale, temporarily change the authentication status of the digital authentication signature to suspended until a confirmation of royalty payment is received, add the scan data to the digital authentication signature, etc.

Process 400, as described above, provides examples of UID element authentication. However, these examples are not meant to be limiting nor meant to represent an exhaustive list of possible implementations. The scope of the technology disclosed herein is not limited to only these examples, and other implementations are contemplated as appreciated by one skilled in the art.

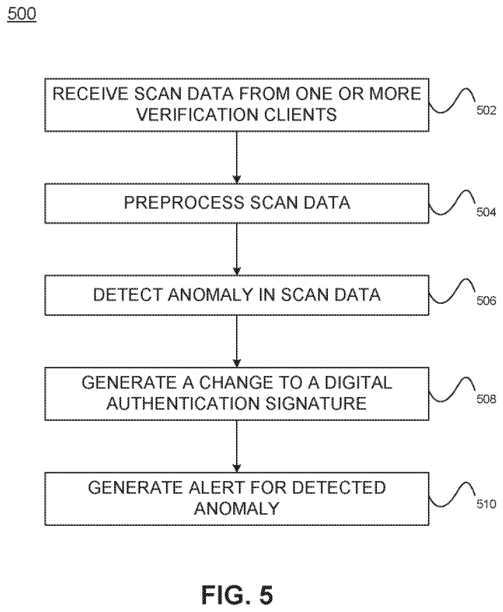

FIG. 5 shows an example process 500, according to some aspects. Process 500 may, for example, describe a process for updating a digital authentication signature corresponding to a physical product based on scan data received from one or more verification clients. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art. Process 500 shall be described with reference to FIG. 1. However, process 500 is not limited to those example aspects.

At 502, DAS 102 may receive scan data from one or more verification clients 104. The scan data may include, but is not limited to, one or more of a timestamp, an identification of each verification client 104, a geolocation of the each verification client 104, proximity data between each verification client 104 and UID element 114, or a scan frequency of one or more UID elements 114.

At 504, DAS 102 may preprocess the scan data. For example, DAS 102 may aggregate scan data from multiple verification clients, aggregate new scan data with previous scan data, extract relevant features from the scan data, perform initial calculations on the scan data, etc.

At 506, DAS 102 may detect one or more anomalies within the scan data. Anomalies may include unexpected patterns within the scan data, including but not limited to, geographic inconsistencies, abnormal scan frequencies, spatiotemporal inconsistencies, unidentified verification clients, and duplicate UIDs. Anomalies may indicate malicious activity. For example, spatiotemporal inconsistencies, duplicate UIDs, and abnormal scan frequencies within the scan data may indicate that a UID element has been cloned, duplicated, or stolen. In another example, scan patterns originating from identical device clusters and high scan repetition may indicate hoarding or other unauthorized automated behavior.

In some aspects, DAS 102 may detect anomalies by comparing the scan data to one or more operational thresholds. The operational thresholds may define authorized geographic zones (e.g., North America), outline a range of allowed or expected scan frequencies for predefined time intervals, define spatiotemporal rules (e.g., minimum time intervals for scans originating from different geographic locations), define minimum verification client trust scores, define a required proximity between a verification client 104 and a UID element 114, etc. In some aspects, the operational thresholds are based on statistical baseline models that define expected ranges for the scan data (e.g., expected scan frequency). An anomaly may be present when one or more aspects of the scan data fail to meet an operational threshold.

In some aspects, DAS 102 may leverage an artificial intelligence model to detect anomalies within the scan data. The artificial intelligence model may include one or more classification models that are configured to extract features from the scan data and classify the features as normal/abnormal. The artificial intelligence model may include separate classification models for different types of anomalies (e.g., a first model to detect abnormal scan patterns, a second model to detect spatiotemporal inconsistencies, etc.). The artificial intelligence model may be trained on historical and/or synthetic UID scan data.

At 508, DAS 102 may generate a change to the digital authentication signature of a physical product 108 based on the detected anomaly. For example, DAS 102 may leverage enforcement engine 118 to enforce actions, such as but not limited to: suspending a digital authentication signature so that properties of the digital authentication signature may not be changed; revoking the authentication status of a digital authentication signature so that the physical product 108 is no longer considered authentic; flagging a digital authentication signature so that the corresponding physical product 108 is still considered authentic, but future scans of the UID element 114 will be monitored with extra scrutiny, and/or adding a temporal limiter to the digital authentication signature that throttles access to rewards or upgrades.

DAS 102 may determine the change to digital authentication signature based on a policy profile associated with the digital authentication signature. The policy profile may specify changes to the digital authentication signature based on a the type of anomaly detected. For example, the policy profile may instruct the enforcement engine to transition the authentication status to restricted upon detection of UID scans from spatiotemporally inconsistent locations or detection of UID scans outside of an authorized geographic zone.

At 510, DAS 102 may generate an alert associated with the detected anomaly. The alert may specify the type of anomaly, provide a timestamp and location for the detected anomaly, etc. DAS 102 may send the alert to entity server(s) 106, directly to a verification client 104, and/or to a user device 110 (e.g., as a notification, text message, etc.).

Process 500, as described above, provides examples of specific anomaly detection schemes. However, these examples are not meant to be limiting nor meant to represent an exhaustive list of possible implementations. The scope of the technology disclosed herein is not limited to only these examples, and other implementations are contemplated as appreciated by one skilled in the art.

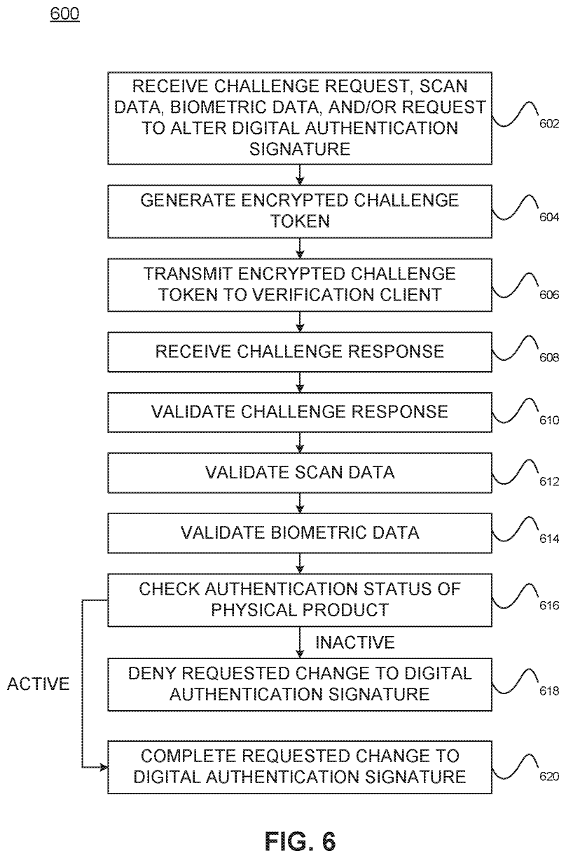

FIG. 6 shows an example process 600, according to some aspects. Process 600 may describe a method for applying multi-factor authentication to validate a scan of a UID element 114. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 6, as will be understood by a person of ordinary skill in the art. Process 600 shall be described with reference to FIG. 1. However, process 600 is not limited to those example aspects.

Multi-factor authentication, as described by process 600, can be leveraged in any of the processes described above (e.g., UID activation, user binding, ownership transfer) or may be leveraged to reinstate a restricted UID. In some aspects, DAS 102 may implement multi-factor authentication when it is specified in a policy profile (e.g., due to low verification client trust score, scan outside of an expected geographic area, etc.). DAS 102 may also use the policy profile to determine the subset and order of operations performed in process 600.

At 602, DAS 102 may receive a challenge request and scan data from verification client 104. The challenge request may include a UID. The scan data may include, but is not limited to, an identifier for verification client 104, a geolocation for verification client 104, a time stamp for a scan of UID element 114 by verification client 104, a confirmation that the UID element 114 was in same geographic location as verification client 104 during the scan, etc. The scan data may additionally include biometric data for a user such as a fingerprint, face ID, heart rate data, galvanic skin response data, or the like.

DAS 102 may also receive a request to alter the digital authentication signature of a physical product 108. The request may include transferring ownership of the UID (e.g., during sale or initial user binding), initial activation of the UID, updating fan engagement data, reinstating a suspended, revoked, or expired UID, etc.

At 604, DAS 102 may, in response to the challenge request, generate an encrypted challenge token. The encrypted challenge token may include a randomly generated value or string unique to the challenge request.

At 606, DAS 102 may transmit the encrypted challenge token to verification client 104. Verification client 104 may transmit the encrypted challenge token to UID element 114, which generates a challenge response. The challenge response may combine the encrypted challenge token with a secret (e.g., through hashing, applying a cryptographic operation, etc.). UID element 114 may transmit the challenge response back to verification client 104, which then transmits the challenge response to DAS 102 for validation.

At 608, DAS 102 may receive the challenge response from verification client 104.

At 610, DAS 102 may validate the challenge response. For example, DAS 102 may compare the challenge response to a public cryptographic key. If the response is invalid, DAS 102 may update the lifecycle state, as recorded in the digital authentication signature, to a restricted or inactive state, as indicated by the policy profile.

In some aspects, the cryptographic authentication process described in operations 604-610 may be repeated multiple times during process 600. For example, process 600 may require that the cryptographic authentication process be repeated N times within a predefined interval, or repeated N times, where each successive iteration is separated by a predefined time interval. Sequential authentication events may also follow a defined interaction pattern. For example, an authentication event may be required each time a user makes a selection on client interface 128 of verification client 104. The predefined intervals or interaction patterns may be defined in policy profile associated with the digital authentication signature of the UID. DAS 102 may generate a unique challenge request for each successive iteration of operations 604-610.

At 612, DAS 102 may validate the scan data received from verification client 104. For example, DAS 102 may compare an identifier of the verification client to a list of authorized verification clients, compare the location of the verification client to an authorized geographic zone, confirm that the UID is in the same geographic location as verification client 104, confirm that there are no spatiotemporal inconsistencies in the scan data, etc. If DAS 102 fails to verify one or more aspects of the scan data, DAS 102 may change the authentication status of the digital authentication signature to a restricted, inactive, or revoked state.

At 614, DAS 102 may validate biometric data obtained from a user. For example, DAS 102 may compare captured faceID or fingerprint data to a user's known biometric data. If the biometric data is invalid, DAS 102 may change the authentication status of the digital authentication signature to a restricted, inactive, or revoked state.

At 616, DAS 102 may check the authentication status of the physical product 108. For example, DAS 102 may check the authentication status of the digital authentication signature associated with physical product 108. If any of the authentication steps described in 610-614 failed, the authentication status may be in an inactive, revoked, or suspended state. In some aspects, the authentication status may have been in an inactive, restricted, revoked or suspended state prior to the initial scan, (e.g., due to detected anomalies, a natural expiration of the UID, etc.). If the authentication status of the digital authentication signature is not active, DAS 102 may deny the request to change the digital authentication signature at 618. If the authentication status of the digital authentication signature is active, DAS 102 may make the requested change to the digital authentication signature at 620. The request change may include transferring ownership of the UID (e.g., during sale or initial user binding), initial activation of the UID, updating fan engagement data, etc.

In some aspects, such as when multifactor authentication is leveraged to reinstate a restricted, suspended, revoked, or expired UID, DAS 102 may alternatively confirm the validity of one or more of the authentication steps outlined in 610-614. If the authentication steps are valid, DAS 102 may change the authentication status of the digital authentication status signature to active at 620. If any of the authentication steps are invalid, the authentication status may remain unchanged.

Process 600, as described above, provides specific examples of multifactor authentication. However, these examples are not meant to be limiting nor meant to represent an exhaustive list of possible implementations. The scope of the technology disclosed herein is not limited to only these examples, and other implementations are contemplated as appreciated by one skilled in the art.

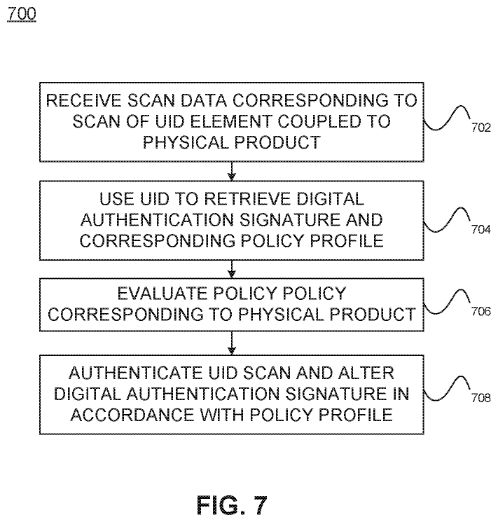

FIG. 7 shows an example process 700, according to some aspects. Process 700 may, for example, describe a process for retrieving data related to a physical product 108. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 7, as will be understood by a person of ordinary skill in the art. Process 700 shall be described with reference to FIG. 1. However, process 700 is not limited to those example aspects.

At 702, DAS 102 may receive scan data corresponding to scan of a UID element 114 coupled to a physical product 108 by a verification client 104. The scan data may include the UID, an identity of the verification client, biometric data of one or more users, a geographic location of the scan, a request to perform an action, etc.

At 704, DAS 102 may use the UID to retrieve the digital authentication signature associated with the physical product 108. As described above in reference to FIG. 1, the digital authentication signature may include an authentication status related to a physical product 108 (e.g., inactive, active, expired, revoked, restricted, suspended, etc.), product-specific information related to the physical product 108 (e.g., a description of physical product 108, information of an entity related to physical product 108, information of a user related to physical product 108, a record of ownership of physical product 108, etc.).

The digital authentication signature may also include (or reference) a policy profile corresponding to the physical product 108. The policy profile may define operations permitted for the physical product and conditions for performing the operations.

At 706, DAS 102 may evaluate the policy corresponding to the physical product. For example, the policy may restrict scans to certain geographic locations, require confirmation of royalty payment before resale, require biometric identification of a user, require multi-factor authentication, require activation scans or ownership transfer requests to originate from an approved verification client, etc.

At 708, DAS 102 may authenticate the UID scan and/or update the digital authentication signature in accordance with the policy profile. For example, DAS 102 may alter the authentication status or ownership of the physical product using any of the steps described above in reference to FIGS. 4 and 6.

In some aspects, DAS 102 may leverage any combination of the processes described in FIGS. 3-7 to maintain persistent identity records of physical products 108 throughout their lifecycles. For example, upon receiving an activation scan of UID element 114 coupled to a physical product 108, DAS 102 may activate a physical product and its corresponding digital authentication signature using process 300, as outlined in reference to FIG. 3. After activation, DAS 102 may receive scan data from additional scans of UID element 114. Additional scans may be tied to a point of sale of the physical product, resale of the physical product, fan interactions (e.g., in a theme parks, at concerts, etc.), or the like. Upon receipt of the scan data, DAS 102 may retrieve a digital authentication signature and policy profile corresponding to the physical product, as described in process 700. DAS 102 may then authenticate the scan using the techniques described in process 400 or process 600 (e.g., through a cryptographic handshake, biometric identification, etc.). After authentication, DAS 102 may make any requested changes to the digital authentication signature in accordance with the policy profile. For example, DAS 102 may update an ownership record of the physical product, update a fan engagement status, reactivate a physical product, etc. DAS 102 may also keep a record of scan data for each scan of the UID element 114. DAS 102 may, using the techniques described in process 500, monitor the scan data for anomalies, such as geographic inconsistencies. When an anomaly is detected DAS 102 may alter the authentication status of the digital authentication signature to suspended or revoked.

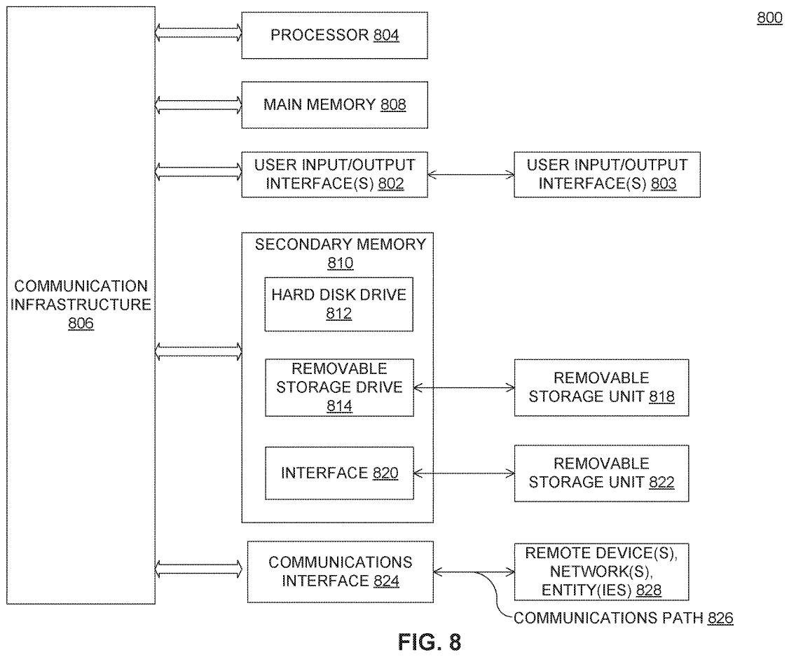

FIG. 8 illustrates an example computer system 800 for implementing various embodiments. Various embodiments may be implemented, for example, using one or more well-known computer systems, such as computer system 800. One or more computer systems 800 may be used, for example, to implement any of the embodiments discussed herein, as well as combinations and sub-combinations thereof, such as DAS 102, verification client(s) 104, entity server(s) 106, UID elements(s) 114, and user device(s) 110.

Computer system 800 may include one or more processors (also called central processing units, or CPUs), such as a processor 804. Processor 804 may be connected to a bus or communication infrastructure 806. The processor 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include user input/output device(s) 803, such as monitors, keyboards, pointing devices, etc., which may communicate with communication infrastructure 806 through user input/output interface(s) 802.

Computer system 800 may also include a primary or main memory 808, such as random access memory (RAM). Main memory 808 may include one or more levels of cache. Main memory 808 may have stored therein control logic (e.g., computer software) and/or data.

Computer system 800 may also include one or more secondary storage devices or secondary memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a first removable storage unit 818. First removable storage unit 818 may include a computer usable or readable storage device having stored thereon computer software (e.g., control logic) and/or data. First removable storage unit 818 may be a floppy disk, magnetic tape, compact disk, digital video disc (DVD), optical storage disk, and/any other computer data storage device. Removable storage drive 814 may read from and/or write to first removable storage unit 818.

Secondary memory 810 may include other means, devices, components, instrumentalities, or other approaches for allowing computer programs and/or other instructions and/or data to be accessed by computer system 800. Such means, devices, components, instrumentalities, or other approaches may include, for example, a second removable storage unit 822 and an interface 820. Examples of the second removable storage unit 822 and the interface 820 may include a program cartridge and cartridge interface (such as that found in video game devices), a removable memory chip (such as an programmable read-only memory (PROM) or erasable PROM (EPROM)) and associated socket, a memory stick and universal serial bus (USB) port, a memory card and associated memory card slot, and/or any other removable storage unit and associated interface.

Computer system 800 may further include a network or communications interface 824. Communications interface 824 may enable computer system 800 to communicate and interact with any combination of external devices, external networks, external entities, etc. (individually and collectively referenced by reference number 828). For example, communications interface 824 may allow computer system 800 to communicate with external or remote device(s), network(s), entity(ies) 828 over communications path 826, which may be wired and/or wireless (or a combination thereof), and which may include any combination of LANs, WANs, the Internet, etc. Control logic and/or data may be transmitted to and from computer system 800 via communications path 826.

Computer system 800 may be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including, but not limited to, remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including, but not limited to, JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (e.g., software) stored thereon may also be referred to herein as a computer program product or program storage device. This may include, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800 or one or more processors 804 thereof), individually or collectively, may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 8. In particular, embodiments may operate with software, hardware, firmware, and/or operating system implementations other than those described herein.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A system comprising: a memory; and one or more processors coupled to the memory and configured to perform operations comprising: linking a digital authentication signature to the physical product based on a unique identifier (UID) element coupled to the physical product and configured to store a cryptographically secure UID; initializing a record associated with the digital authentication signature to track each scan of the UID element and each change to the digital authentication signature; receiving, from a verification client, an activation scan of the UID element, wherein the activation scan contains the UID associated with the product and a challenge request; generating, based on the challenge request, an encrypted challenge token; transmitting the encrypted challenge token to the verification client; receiving, from the verification client, a challenge response, wherein the challenge response contains the encrypted challenge token and the UID; changing an authentication status of the physical product corresponding to the digital authentication signature to active, wherein the changing comprises: validating that the challenge response corresponding to the activation scan is correct; updating the record associated with the digital authentication signature; outputting, via the verification client, the authentication status of the physical product based on the digital authentication signature.

Example 2. The system of Example 1, wherein the verification client is either an authorized point-of-sale (POS) system configured to generate the activation scan during an initial sale of the physical product or an authorized authentication device configured to generate the activation scan during a secured coupling of the UID element to the physical product.

Example 3. The system of Example 1 or 2, the operations further comprising: displaying, via at least one of an entity dashboard or a user interface, one or more digital authentication signatures corresponding to physical products associated with at least one of an entity or a user.

Example 4. The system of Examples 1-3, the operations further comprising: receiving, from at least one of the entity dashboard or the user interface, information related to the one or more digital authentication signatures; generating a change to the one or more digital authentication signatures based on the information; and updating the record associated with the digital authentication signature based on the change.

Example 5. The system of Example 4, wherein the information related to the one or more digital authentication signatures includes an authorized sale of the physical product.

Example 6. The system of Examples 1-5, the operations further comprising: receiving, from the verification client, scan data, wherein the scan data comprises at least one of a timestamp, an identification of the verification client, or a geolocation of the verification client.

Example 7. The system of Examples 1-6, the operations further comprising: detecting an anomaly based on the scan data and the record associated with the digital authentication signature; generating a change to the authentication status based on the anomaly; and updating the record associated with the digital authentication signature based on the change.

Example 8. The system of Example 7, wherein the change to the authentication status indicates revocation or suspension of the UID.

Example 9. The system of Examples 1-8, the operations further comprising: receiving user information from the verification client; and updating the record associated with the digital authentication signature to include the user information.

Example 10. The system of Examples 1-9, the operations further comprising: receiving, from another verification client, a second scan of the UID element, wherein the second scan contains the UID representing the physical product, user information, and another challenge request; generating, based on the another challenge request, another encrypted challenge token; transmitting the another encrypted challenge token to the another verification client; receiving, from the another verification client, another challenge response, wherein the another challenge response contains the another encrypted challenge token and the UID; and validating that the another challenge response corresponding to the another activation scan is correct.

Example 11. The system of Examples 1-10, the operations further comprising: receiving, from the another verification client, telemetry data; verifying, using the telemetry data, that the UID element is in proximity of the another verification client.

Example 12. The system of Examples 1-11, the operations further comprising: verifying the authentication status of the physical product.

Example 13. The system of Examples 1-12, the operations further comprising: updating the record associated the digital authentication signature to include the user information.

Example 14. A computer-implemented method for authenticating a physical product, comprising: linking a digital authentication signature to the physical product based on a unique identifier (UID) chip coupled to the physical product and configured to store a cryptographically secure UID; initializing a record associated with the digital authentication signature to track each scan of the UID element and each change to the digital authentication signature; receiving, from a verification client, an activation scan of the UID element, wherein the activation scan contains the UID associated with the product and a challenge request; generating, based on the challenge request, an encrypted challenge token; transmitting the encrypted challenge token to the verification client; receiving, from the verification client, a challenge response, wherein the challenge response contains the encrypted challenge token and the UID; changing an authentication status of the physical product corresponding to the digital authentication signature to active, wherein the changing comprises: validating that the challenge response corresponding to the activation scan is correct; updating the record associated with the digital authentication signature; outputting, via the verification client, the authentication status of the physical product based on the digital authentication signature.

Example 15. The computer-implemented method of Example 14, wherein the verification client is either an authorized point-of-sale (POS) system configured to generate the activation scan during an initial sale of the physical product or an authorized authentication device configured to generate the activation scan during a secured coupling of the UID element to the physical product.

Example 16. The computer-implemented method of Example 14 or 15, further comprising: displaying, via at least one of an entity dashboard or a user interface, one or more digital authentication signatures corresponding to physical products associated with at least one of an entity or a user.

Example 17. The computer-implemented method of Examples 14-16, further comprising: receiving, from at least one of the entity dashboard or the user interface, information related to the one or more digital authentication signatures; generating a change to the one or more digital authentication signatures based on the information; and updating the record associated with the digital authentication signature based on the change.

Example 18. The computer-implemented method of Example 17, wherein the information related to the one or more digital authentication signatures includes an authorized sale of the physical product.

Example 19. The computer-implemented method of Examples 14-18, further comprising: receiving, from the verification client, scan data, wherein the scan data comprises at least one of a timestamp, an identification of the verification client, or a geolocation of the verification client.

Example 20. The computer-implemented method of Examples 14-19, further comprising: detecting an anomaly based on the scan data and the record associated with the digital authentication signature; generating a change to the authentication status based on the anomaly; and updating the record associated with the digital authentication signature based on the change.

Example 21. The computer-implemented method of Example 20, wherein the change to the authentication status indicates revocation or suspension of the UID.

Example 22. The computer-implemented method of Examples 14-21, further comprising: receiving user information from the verification client; and updating the record associated with the digital authentication signature to include the user information.

Example 23. The computer-implemented method of Examples 14-22, further comprising: receiving, from another verification client, a second scan of the UID element, wherein the second scan contains the UID representing the physical product, user information, and another challenge request; generating, based on the another challenge request, another encrypted challenge token; transmitting the another encrypted challenge token to the another verification client; receiving, from the another verification client, another challenge response, wherein the another challenge response contains the another encrypted challenge token and the UID; and validating that the another challenge response corresponding to the another activation scan is correct.

Example 24. The computer-implemented method of Examples 14-23, further comprising: receiving, from the another verification client, telemetry data; verifying, using the telemetry data, that the UID element is in proximity of the another verification client.

Example 25. The computer-implemented method of Examples 14-24, further comprising: verifying the authentication status of the physical product.

Example 26. The computer-implemented method of Examples 14-25, further comprising: updating the record associated the digital authentication signature to include the user information.

Example 27. A non-transitory machine-readable storage medium having instructions stored thereon that, when executed by at least one computing device, causes the at least one computing device to perform operations comprising: linking a digital authentication signature to a physical product based on a unique identifier (UID) chip coupled to the physical product and configured to store a cryptographically secure UID; initializing a record associated with the digital authentication signature to track each scan of the UID element and each change to the digital authentication signature; receiving, from a verification client, an activation scan of the UID element, wherein the activation scan contains the UID associated with the product and a challenge request; generating, based on the challenge request, an encrypted challenge token; transmitting the encrypted challenge token to the verification client; receiving, from the verification client, a challenge response, wherein the challenge response contains the encrypted challenge token and the UID; changing an authentication status of the physical product corresponding to the digital authentication signature to active, wherein the changing comprises: validating that the challenge response corresponding to the activation scan is correct; updating the record associated with the digital authentication signature; outputting, via the verification client, the authentication status of the physical product based on the digital authentication signature.

Example 28. The non-transitory machine-readable storage medium of Example 27, wherein the verification client is either an authorized point-of-sale (POS) system configured to generate the activation scan during an initial sale of the physical product or an authorized authentication device configured to generate the activation scan during a secured coupling of the UID element to the physical product.

Example 29. The non-transitory machine-readable storage medium of Example 27 or 28, the operations further comprising: displaying, via at least one of an entity dashboard or a user interface, one or more digital authentication signatures corresponding to physical products associated with at least one of an entity or a user.

Example 30. The non-transitory machine-readable storage medium of Examples 27-29, the operations further comprising: receiving, from at least one of the entity dashboard or the user interface, information related to the one or more digital authentication signatures; generating a change to the one or more digital authentication signatures based on the information; and updating the record associated with the digital authentication signature based on the change.

Example 31. The non-transitory machine-readable storage medium of Example 30, wherein the information related to the one or more digital authentication signatures includes an authorized sale of the physical product.

Example 32. The non-transitory machine-readable storage medium of Examples 27-31, the operations further comprising: receiving, from the verification client, scan data, wherein the scan data comprises at least one of a timestamp, an identification of the verification client, or a geolocation of the verification client.

Example 33. The non-transitory machine-readable storage medium of Examples 27-32, the operations further comprising: detecting an anomaly based on the scan data and the record associated with the digital authentication signature; generating a change to the authentication status based on the anomaly; and updating the record associated with the digital authentication signature based on the change.

Example 34. The non-transitory machine-readable storage medium of Example 33, wherein the change to the authentication status indicates revocation or suspension of the UID.

Example 35. The non-transitory machine-readable storage medium of Examples 27-34, the operations further comprising: receiving user information from the verification client; and updating the record associated with the digital authentication signature to include the user information.

Example 36. The non-transitory machine-readable storage medium of Examples 27-35, the operations further comprising: receiving, from another verification client, a second scan of the UID element, wherein the second scan contains the UID representing the physical product, user information, and another challenge request; generating, based on the another challenge request, another encrypted challenge token; transmitting the another encrypted challenge token to the another verification client; receiving, from the another verification client, another challenge response, wherein the another challenge response contains the another encrypted challenge token and the UID; and validating that the another challenge response corresponding to the another activation scan is correct.

Example 37. The non-transitory machine-readable storage medium of Examples 27-36, the operations further comprising: receiving, from the another verification client, telemetry data; verifying, using the telemetry data, that the UID element is in proximity of the another verification client.

Example 38. The non-transitory machine-readable storage medium of Examples 27-37, the operations further comprising: verifying the authentication status of the physical product.

Example 39. The non-transitory machine-readable storage medium of Examples 27-38, the operations further comprising: updating the record associated the digital authentication signature to include the user information.

It is to be appreciated that the Detailed Description section, and not any other section, is intended to be used to interpret the claims. Other sections may set forth one or more, but not all, exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries may be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for authenticating a physical product, comprising:
linking a digital authentication signature to the physical product based on a unique identifier (UID) chip coupled to the physical product and configured to store a cryptographically secure UID;
initializing a record associated with the digital authentication signature to track each scan of the UID element and each change to the digital authentication signature;
receiving, from a verification client, an activation scan of the UID element, wherein the activation scan contains the UID associated with the product and a challenge request;
generating, based on the challenge request, an encrypted challenge token;
transmitting the encrypted challenge token to the verification client;
receiving, from the verification client, a challenge response, wherein the challenge response contains the encrypted challenge token and the UID;
changing an authentication status of the physical product corresponding to the digital authentication signature to active, wherein the changing comprises:
validating that the challenge response corresponding to the activation scan is correct;
updating the record associated with the digital authentication signature;
outputting, via the verification client, the authentication status of the physical product based on the digital authentication signature.

2. The computer-implemented method of claim 1, wherein the verification client is either an authorized point-of-sale (POS) system configured to generate the activation scan during an initial sale of the physical product or an authorized authentication device configured to generate the activation scan during a secured coupling of the UID element to the physical product.

3. The computer-implemented method of claim 1, further comprising:
displaying, via at least one of an entity dashboard or a user interface, one or more digital authentication signatures corresponding to physical products associated with at least one of an entity or a user.

4. The computer-implemented method of claim 3, further comprising:
receiving, from at least one of the entity dashboard or the user interface, information related to the one or more digital authentication signatures;
generating a change to the one or more digital authentication signatures based on the information; and
updating the record associated with the digital authentication signature based on the change.

5. The computer-implemented method of claim 4, wherein the information related to the one or more digital authentication signatures includes an authorized sale of the physical product.

6. The computer-implemented method of claim 1, further comprising:
receiving, from the verification client, scan data, wherein the scan data comprises at least one of a timestamp, an identification of the verification client, or a geolocation of the verification client.

7. The computer-implemented method of claim 6, further comprising:
detecting an anomaly based on the scan data and the record associated with the digital authentication signature;
generating a change to the authentication status based on the anomaly; and
updating the record associated with the digital authentication signature based on the change.

8. The computer-implemented method of claim 7, wherein the change to the authentication status indicates revocation or suspension of the UID.

9. The computer-implemented method of claim 1, further comprising:
receiving user information from the verification client; and
updating the record associated with the digital authentication signature to include the user information.

10. The computer-implemented method of claim 1, further comprising:
receiving, from another verification client, a second scan of the UID element, wherein the second scan contains the UID representing the physical product, user information, and another challenge request;
generating, based on the another challenge request, another encrypted challenge token;
transmitting the another encrypted challenge token to the another verification client;
receiving, from the another verification client, another challenge response, wherein the another challenge response contains the another encrypted challenge token and the UID; and
validating that the another challenge response corresponding to the another activation scan is correct.

11. The computer-implemented method of claim 10, further comprising:
receiving, from the another verification client, telemetry data;
verifying, using the telemetry data, that the UID element is in proximity of the another verification client.

12. The computer-implemented method of claim 11, further comprising:
verifying the authentication status of the physical product.

13. The computer-implemented method of claim 10, further comprising:
updating the record associated the digital authentication signature to include the user information.

14. A system for authenticating a physical product, comprising:
a memory; and
one or more processors coupled to the memory and configured to perform operations comprising:
linking a digital authentication signature to the physical product based on a unique identifier (UID) element coupled to the physical product and configured to store a cryptographically secure UID;
initializing a record associated with the digital authentication signature to track each scan of the UID element and each change to the digital authentication signature;
receiving, from a verification client, an activation scan of the UID element, wherein the activation scan contains the UID associated with the product and a challenge request;
generating, based on the challenge request, an encrypted challenge token;
transmitting the encrypted challenge token to the verification client;
receiving, from the verification client, a challenge response, wherein the challenge response contains the encrypted challenge token and the UID;
changing an authentication status of the physical product corresponding to the digital authentication signature to active, wherein the changing comprises:
validating that the challenge response corresponding to the activation scan is correct;
updating the record associated with the digital authentication signature;
outputting, via the verification client, the authentication status of the physical product based on the digital authentication signature.

15. The system of claim 14, the operations further comprising:
receiving, from at least one of an entity dashboard or a user interface, information related to the one or more digital authentication signatures;
generating a change to the one or more digital authentication signatures based on the information; and
updating the record associated with the digital authentication signature based on the change.

16. The system of claim 14, the operations further comprising:
receiving, from the verification client, scan data, wherein the scan data comprises at least one of a timestamp, an identification of the verification client, or a geolocation of the verification client.

17. The system of claim 16, the operations further comprising:
detecting an anomaly based on the scan data and the record associated with the digital authentication signature;
generating a change to the authentication status based on the anomaly, wherein the change to the authentication status indicates revocation or suspension of the UID; and
updating the record associated with the digital authentication signature based on the change.

18. The system of claim 14, the operations further comprising:
receiving, from another verification client, a second scan of the UID element, wherein the second scan contains the UID representing the physical product, user information, and another challenge request;
generating, based on the another challenge request, another encrypted challenge token;
transmitting the another encrypted challenge token to the another verification client;
receiving, from the another verification client, another challenge response, wherein the another challenge response contains the another encrypted challenge token and the UID; and
validating that the another challenge response corresponding to the another activation scan is correct.

19. The system of claim 18, the operations further comprising:
receiving, from the another verification client, telemetry data;
verifying, using the telemetry data, that the UID element is in proximity of the another verification client.

20. The system of claim 19, the operations further comprising:
verifying the authentication status of the physical product; and
updating the record associated the digital authentication signature to include the user information.

21. A non-transitory machine-readable storage medium having instructions stored thereon that, when executed by at least one computing device, causes the at least one computing device to perform operations comprising:
linking a digital authentication signature to a physical product based on a unique identifier (UID) chip coupled to the physical product and configured to store a cryptographically secure UID;
initializing a record associated with the digital authentication signature to track each scan of the UID element and each change to the digital authentication signature;
receiving, from a verification client, an activation scan of the UID element, wherein the activation scan contains the UID associated with the product and a challenge request;
generating, based on the challenge request, an encrypted challenge token;
transmitting the encrypted challenge token to the verification client;
receiving, from the verification client, a challenge response, wherein the challenge response contains the encrypted challenge token and the UID;
changing an authentication status of the physical product corresponding to the digital authentication signature to active, wherein the changing comprises:
validating that the challenge response corresponding to the activation scan is correct;
updating the record associated with the digital authentication signature;
outputting, via the verification client, the authentication status of the physical product based on the digital authentication signature.

22. The non-transitory machine-readable storage medium of claim 21, the operations further comprising:
receiving, from at least one of an entity dashboard or a user interface, information related to the one or more digital authentication signatures;
generating a change to the one or more digital authentication signatures based on the information; and
updating the record associated with the digital authentication signature based on the change.

23. The non-transitory machine-readable storage medium of claim 21, the operations further comprising:
receiving, from the verification client, scan data, wherein the scan data comprises at least one of a timestamp, an identification of the verification client, or a geolocation of the verification client.

24. The non-transitory machine-readable storage medium of claim 23, the operations further comprising:
detecting an anomaly based on the scan data and the record associated with the digital authentication signature;
generating a change to the authentication status based on the anomaly; and
updating the record associated with the digital authentication signature based on the change.

25. The non-transitory machine-readable storage medium of claim 24, wherein the change to the authentication status indicates revocation or suspension of the UID.

26. The non-transitory machine-readable storage medium of claim 21, the operations further comprising:
receiving user information from the verification client; and
updating the record associated with the digital authentication signature to include the user information.

27. The non-transitory machine-readable storage medium of claim 21, the operations further comprising:
receiving, from another verification client, a second scan of the UID element, wherein the second scan contains the UID representing the physical product, user information, and another challenge request;
generating, based on the another challenge request, another encrypted challenge token;
transmitting the another encrypted challenge token to the another verification client;
receiving, from the another verification client, another challenge response, wherein the another challenge response contains the another encrypted challenge token and the UID; and
validating that the another challenge response corresponding to the another activation scan is correct.

28. The non-transitory machine-readable storage medium of claim 27, the operations further comprising:
receiving, from the another verification client, telemetry data;
verifying, using the telemetry data, that the UID element is in proximity of the another verification client.

29. The non-transitory machine-readable storage medium of claim 28, the operations further comprising:
verifying the authentication status of the physical product.

30. The non-transitory machine-readable storage medium of claim 27, the operations further comprising:
updating the record associated the digital authentication signature to include the user information.
